(19) United States
(12) Patent Application Publication
(10) Pub. No.: US 2014/0308060 A1
(43) Pub. Date: Oct. 16, 2014

(54) ULTIMATE ORGANIZER

(71) Applicant: Jeffrey Perry, Dana Point, CA (US)

(72) Inventor: Jeffrey Perry, Dana Point, CA (US)

(21) Appl. No.: 14/253,771

(22) Filed: Apr. 15, 2014

Related U.S. Application Data
(60) Provisional application No. 61/812,185, filed on Apr. 15, 2013.

(51) Int. Cl. B42F 3/04

(52) U.S. Cl. CPC B42F 3/04
USPC 402/74

(57) ABSTRACT

The Ultimate Organizer comprises a cloth covered hard covered ring binder having a series of interior envelope or pocket pages having one, two, or four pockets, wherein the pockets are secured by hook and loop fasteners. The face of each pocket in every pocket page style is outfitted with a transparent window. A keychain rack is mounted inside the back cover.

### CLAIM OF PRIORITY

This patent application claims priority under 35 USC 119 (e) (1) from U.S. Provisional Patent Application Ser. No. 61/812,185 filed Apr. 15, 2013, of common inventorship herewith entitled, “Ultimate Organizer.”

### FIELD OF THE INVENTION

The present invention pertains to the field of business supplies, and more specifically to the field of binder organizational systems.

### BACKGROUND OF THE INVENTION

The prior art has put forth several designs for binder organizational systems. Among these are:

U.S. Pat. No. 6,161,979 to Norman Yamamoto, Bruce Allen Carter and Thomas M. Wien describes a binder assembly having a partition or intermediate panel separating a ring binder compartment from a storage compartment. The binder assembly includes a spine, a rear cover, a front cover and an intermediate panel. The rear cover and front cover are pivotally or flexibly mounted adjacent the spine. The rear cover and intermediate panel define a ring binder space for holding pages, closed on one side where the rear and front cover are secured to the spine and being selectively open on the other three sides. A ring binder is mounted in the ring binder space near the spine. A front cover is pivotally mounted to the intermediate panel. The intermediate panel and the front cover define a storage space closed on one side where the front cover is secured to the intermediate panel and being selectively open on the other three sides. First and second zippers extend around the three open sides of the binder and storage space respectively, to fully enclose contents of the binder assembly.

U.S. Pat. No. 5,911,441 to Norman Curtis Yamamoto and Bruce A. Carter describes an improved carrying case which is capable of storing a pad of fresh writing paper wherein the pad of paper is stored in a pocket that encloses the pad and protects it from being exposed to the outside elements. The notepad is easily accessible to the user, without having to open the case to expose papers contained within the interior of the case. The user may write upon a fresh pad of paper without opening the interior of the carrying case. The carrying case is sturdy enough so the user has a sufficiently stable surface to write upon the notepad without removing the notepad from its pocket.

U.S. Pat. No. 5,494,366 to Herbert C. Pell and Eugenia S. D. Pell describes an organizer notebook having front and rear covers hingedly secured to one another. The inner face of one of the covers has pockets for receipt and retention of personal items such as pens, pencils and the like. The inner surface of the other cover has document retention means in the form of a pair of opposed flaps foldably secured to the cover beneath which papers and other documents can be placed in an organized manner. The flaps are securable to one another by a closure.

None of these prior art references describe the present invention.

### SUMMARY OF THE INVENTION

It is an object of the present invention to provide a ring binder organizational system which greatly facilitates and manages a plethora of items.

### BRIEF DESCRIPTION OF THE DRAWINGS

FIG. 1 is an illustrative prototypical opened view of the present invention showing hook and loop fastener tabs, binding, plastic sheets with envelopes, and business card size slip pockets for custom labels.

FIG. 2 is an illustrative prototypical closed view of the present invention showing a custom cover label and a business card size slip pocket for identification.

FIG. 3 is an illustrative prototypical opened view of the present invention showing pages turning and a keychain rack on inside back cover.

FIG. 4 is an illustrative prototypical opened view of the present invention showing an optional full size page insert and loose pre lined cards or paper slipped inside pockets.

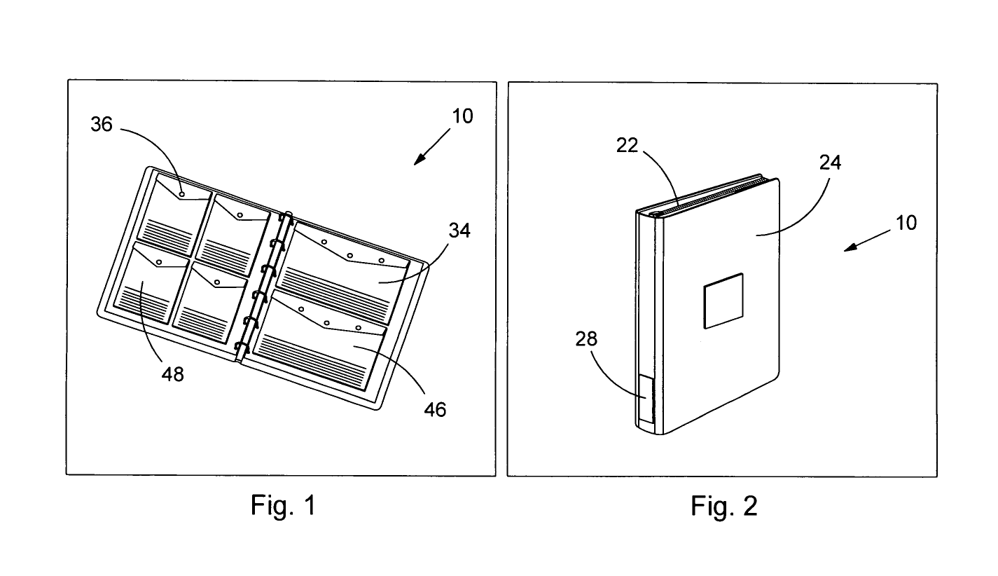

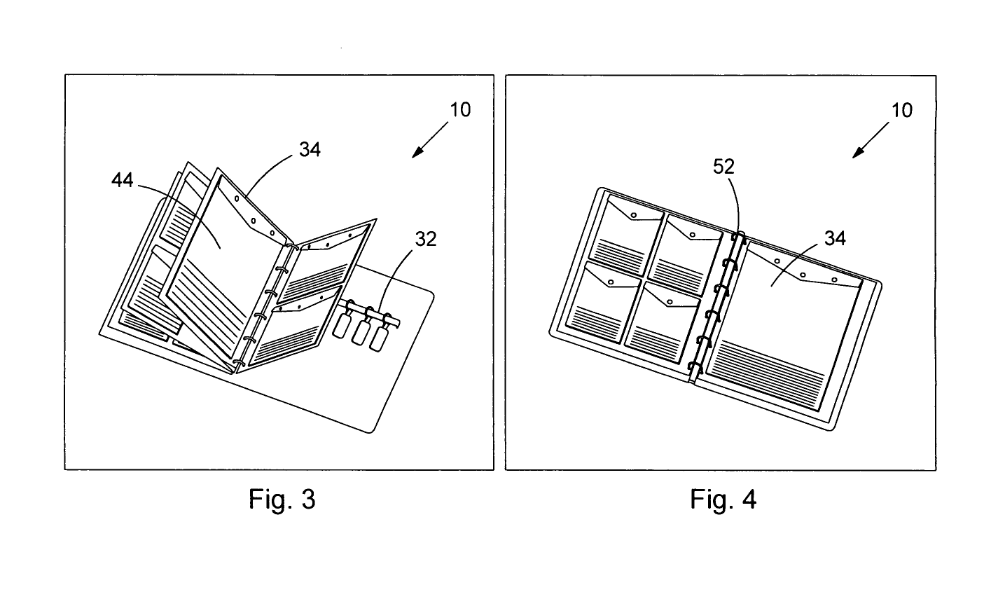

### DETAILED DESCRIPTION OF THE INVENTION

Owning and managing multiple rental properties is a huge logistical challenge. Each property requires different and disparate items to be kept on file. These range from keys and gate pass codes to information regarding maintenance personnel and site specific wireless internet passwords. Managing all these numbers, keys and other items quickly becomes a quagmire, especially if one doesn't have an appropriate filing system for keeping track of all properties and their relevant information. Keys must be properly labeled and specific information for each address stored in an organized and easily accessible location to ascertain correct codes for gate access and internet setups. Current available products provide very limited space in which to label multiple keys and the keys are affixed directly to an organizer with a means of clip or bar fastener that makes getting keys in and out of the organizer quite difficult, especially for individuals with long and delicately decorated fingernails. These current key logs focus mostly on storing keys and provide scant storage space for associated information. Property owners or managers are forced to juggle a variety of different logs and organizers to have ready access to pertinent details and relevant information when dealing with a particular rental unit.

The present invention, hereinafter referred to as the Ultimate Organizer, is a cloth bound and hard covered ring binder organizational system that facilitates and manages the process of organizing a plethora of items. The Ultimate Organizer is a single location solution for landlords and property managers managing multiple rental units. Originally developed specifically for multi location access verification and authentication markets, the Ultimate Organizer also provides an optimal system for managing all manner of labeled small object sorting and storage.

The primary constituent element of the Ultimate Organizer system is a cloth bound and hard covered ring binder 10 designed with closing flaps and a securing zipper 22 stitched around its periphery for easy zip closing. The exterior cover surfaces 24 of the device are rectangular in shape and measure approximately nine inches in length, and twelve inches in width, The binding is approximately, and two to three inches in depth. The binding 26 includes a small transparent plastic label display window 28 secured in place along the binding and is sized to readily accept a regular sized business card. Stiff cardboard sealed in plastic provides a supporting core upon which a fabric cover is constructed. The front cover is integrated along three sides with a tough fabric border. The front cover also includes a small transparent plastic label display window 30. The window is sized to readily accept a regular sized business card inscribed with the relevant labeling information. The Ultimate organizer is approximately two to three inches in depth and contains an optional keychain rack 32 to placed within the back cover of the present invention.

The Ultimate Organizer consists of a series of interior envelope or pocket pages 34 composed of multiple sheets of transparent plastic that is heat bonded together to form expandable and securable pockets. Containing hook and loop tabs 36 for secure sealing, these interior envelope pages are manufactured in three different styles. The first and largest envelope page style takes up approximately eight and one half by eleven inches available inside the Ultimate Organizer and contains a single large pocket of similar size. These large pockets 44 are ideal for holding a papers or a number of different objects together. The second pocket page style 46 is a one half page format. While these plastic sheets are approximately eight and one half inches wide and eleven inches tall, they are subdivided horizontally and tangential to a midpoint of a vertical axis, creating two equally sized pockets with wide aspect rations. These pockets are approximately eight and one half inches wide and five and one half inches tall. This style is ideal for storing cell phone sized devices, access cards and other smaller accoutrements. The third pocket page style 48 is a one quarter page envelope, adding a second subdividing seam running vertically through a midpoint of a horizontal axis perpendicular to the seam employed in the one half page format. This format results in four smaller pockets with each pocket having an aspect ratio matching that of a full page pocket but one quarter of a full page size. These pockets are ideal for storing keys with small key fobs and other tiny objects. The face of each pocket in every envelope page style is outfitted with a transparent window capable of storing and displaying a business card sized label. Each envelope page has a small plastic strip running along its left hand side, perforated in locations so the envelope page is easily slipped in and out of the Ultimate Organizer's ring binder 52.

The Ultimate Organizer ships with one sheet of each envelope size as well as a hard cardboard page for recording gate and lock box codes. Included in the package is a perforated sheet of labeling cards that easily break down into ten business card sized pieces. This label paper functions equally well as a surface for handwriting, ink jet or laser printing. Additional packages of labeling paper and envelope pages in various sizes are available for purchase separately, allowing each user to customize the internal layout of their own Ultimate Organizer optimally for their specific needs.

Using an Ultimate Organizer is a relatively straightforward affair. The user selects an Ultimate Organizer book that is the appropriate size for their operation and is finished in a color and pattern that matches their look. This Ultimate Organizer is purchased and brought to one's home or place of business. Information relating to the various properties being managed or other items being organized are printed or written on the business card sized labels provided as a perforated sheet. Once the labels are correctly addressed, they are broken apart from one another along the perforation lines and inserted into appropriate label display pockets on the front cover and envelope pages of the Ultimate Organizer. After all the pockets are labeled, appropriate keys and other devices are placed inside them and The Ultimate Organizer is zipped in its closed position for safe storage. As items from various pockets are needed, they are removed, used and replaced. As one's organizational needs grow, more envelope pages are purchased and labeled in a similar fashion.

The easily expandable nature of the Ultimate Organizer ensures that users have enough storage space for the number of keys they actually have, without fear of exceeding their storage capacity limitations in the future. The Ultimate Organizer's unique labeling system provides significantly more capacity for information storage than tiny key fobs used in most key management systems. The capability to machine print a label provides a clean professional look. Transparent pockets ensure the user is able to ascertain rapidly where keys and other security devices are located and obtain the correctly corresponding items every time.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A binder organizational system which greatly facilitates and manages a plethora of items, comprising: a ring binder having cloth binding and hard covers, and a hard binding, with closing flaps and a securing zipper stitched around its periphery for easy zip closing, further comprising at least one interior page, wherein the interior page comprises at least one pocket.

2. The binder organizational system of claim 1, wherein exterior cover surfaces of the device are rectangular in shape and measure approximately nine inches in length, and twelve inches in width, and the binding is approximately, and two to three inches in depth.

3. The binder organizational system of claim 1, wherein the binding includes a small transparent plastic label display window secured in place along the binding and is sized to readily accept a regular sized business card.

4. The binder organizational system of claim 2, wherein the front cover includes a small transparent plastic label display window, wherein the window is sized to readily accept a regular sized business card.

5. The binder organizational system of claim 2, further comprising a keychain rack placed within the back cover of the binder.

6. The binder organizational system of claim 5, wherein the interior page comprises a pocket composed of transparent plastic that is heat bonded together to form one or more expandable and securable pockets.

7. The binder organizational system of claim 6, further comprising hook and loop tabs for secure sealing the pockets.

8. The binder organizational system of claim 5, wherein the interior page comprises one pocket and the pocket is approximately eight and one half inches by eleven inches.

9. The binder organizational system of claim 5, wherein the interior page comprises two pockets, wherein each pocket is a one half page format, and each pocket measures approximately eight and one half inches wide and five and one half inches tall.

10. The binder organizational system of claim 5, wherein the interior page comprises four pockets, wherein each pocket is a one quarter page format, and each pocket measures approximately four and one quarter inches wide and five and one half inches tall.

11. The binder organizational system of claim 8, wherein the face of each pocket is outfitted with a transparent window capable of storing and displaying a business card sized label.

12. The binder organizational system of claim 9, wherein the face of each pocket is outfitted with a transparent window capable of storing and displaying a business card sized label.

13. The binder organizational system of claim 10, wherein the face of each pocket is outfitted with a transparent window capable of storing and displaying a business card sized label.

14. The binder organizational system of claim 8, wherein each envelope page has a small plastic strip running along its left hand side, wherein the strip is perforated in locations so the envelope page is easily slipped in and out of the ring binder.

15. The binder organizational system of claim 9, wherein each envelope page has a small plastic strip running along its left hand side, wherein the strip is perforated in locations so the envelope page is easily slipped in and out of the ring binder.

16. The binder organizational system of claim 10, wherein each envelope page has a small plastic strip running along its left hand side, wherein the strip is perforated in locations so the envelope page is easily slipped in and out of the ring binder.
